(19) United States
(12) Patent Application Publication
(10) Pub. No.: US 2024/0342715 A1
(43) Pub. Date: Oct. 17, 2024

(54) BIOLOGICAL SAMPLE DRIVING SYSTEM AND METHOD

(71) Applicant: Beckman Coulter, Inc., Miami, FL (US)

(72) Inventors: Bart WANDERS, Miami, FL (US); Joanna JOHNSON, Chaska, MN (US); Gabriel SANTOS, Miami, FL (US)

(21) Appl. No.: 18/750,714

(22) Filed: Jun. 21, 2024

Related U.S. Application Data
(63) Continuation of application No. PCT/US2022/054240, filed on Dec. 29, 2022.
(60) Provisional application No. 63/294,648, filed on Dec. 29, 2021.

(51) Int. Cl. B01L 3/00

(52) U.S. Cl. CPC B01L 3/50273; B01L 2200/0673; B01L 2300/0877; B01L 2400/0622; B01L 2400/082

(57) ABSTRACT

A biological analysis system includes a flow generator, a flowcell, a first flow path, and a second flow path. The flow generator is configured to provide a sheath fluid. The flowcell is configured to receive a biological sample. The first flow path is in fluid communication with the flow generator and configured to receive a first portion of the sheath fluid from the flow generator. The first flow path is configured to convey the biological sample using the first portion to the flowcell at a first flow rate. The second flow path is in fluid communication with the flow generator and configured to receive a second portion of the sheath fluid from the flow generator. The second flow path is configured to convey the second portion to the flowcell at a second flow rate. The second flow rate is different than the first flow rate.

### PRIORITY

This is a continuation of, and claims the benefit of, international application PCT/US22/54240, entitled “Biological Sample Driving System and Method,” filed on Dec. 29, 2022, which itself claims the filing benefit of U.S. Prov. Pat. App. No. 63/294,648 entitled “Biological Sample Driving System and Method,” filed on Dec. 29, 2021, the disclosure of which is incorporated by reference herein, in its entirety.

### BACKGROUND

In biological analyzers (e.g., body fluid analyzers and hematology analyzers), biological samples are driven through a flowcell for analysis. These biological samples may include blood samples and/or other body fluid samples. The biological samples are typically surrounded by sheath fluid to hydrodynamically focus the biological sample into a thin stream through the analysis region of the flowcell. The sheath fluid flow and the blood or other body fluid sample flow should be carefully calibrated and controlled to ensure the flowcell analysis is accurate.

Some hematology systems use two separate chambers/reservoirs each partially filled with liquid and pressurized with air. One chamber is used to obtain the desired sheath flow and the other chamber used to obtain the desired sample flow. The chambers are set to different pressures and the pressure of the chambers is monitored by software. However, a two-chamber system is sensitive to variations in air pressure in the two chambers. As a result, the two-chamber system may incorporate specially procured air pressure regulators and custom designed sheath restrictors comprising of capillary glass which are susceptible to changes in temperature and fluid viscosity. This may separately affect the relative flow rates/fluid properties of the sheath fluid and sample fluid.

Other hematology systems may use a two chamber and two-pump driven sample flow system, where each of a first and second chamber is connected to its own pump and each pump is used to generate a particular fluid delivery flow rate. For example, two high precision syringe pumps may be used, where a first syringe pump is fluidically connected to a first liquid-containing chamber and drives a sheath flow, and a second pump is fluidically connected to a second liquid-containing chamber and drives a sample flow. Each of the high precision syringe pumps operates at a different speed (flow rate) to drive the sheath fluid and sample through the flowcell. However, pump driven systems utilize mechanical components and electronic motor controls to achieve stable flow which are susceptible to device-to-device variability. Additionally, the total amount of sheath fluid that can be delivered to the system is limited by the size of the syringe pump. Furthermore, these sample flow systems incorporating high precision syringe pumps may be expensive.

Systems may use quantitative control and/or qualitative control to assess system performance and obtain accurate and precise results. Quantitative control uses precise measurements in numerical form to control the system. Qualitative control uses characteristics (e.g., image focus and clarity) to assess system performance. For a biological imaging system, it is beneficial to image an accurate and precise volume of fluid to ensure quantitative control. In other words, it is beneficial to control the volume of fluid analyzed in each discrete image to ensure accurate counting. For example, undercounting may result is if the actual volume is less than the expected volume. Conversely, overcounting may result is if the actual volume is more than expected volume. The volume is defined as the product of the imaged area of the ribbon and the thickness of the ribbon. The imaged area of the ribbon is determined by the optical system and is the product of the width and the height of the field of view). It is beneficial to carefully control the thickness of the ribbon. The sheath and sample flow may be carefully controlled and calibrated to ensure quantitative control. This calibration and control may be beneficial in a flow imaging system, where the material is imaged as the material flows through a flowcell where that material being analyzed (e.g., cellular material such as blood cells) is imaged to correctly classify and count the cells.

There is a need to maintain a sheath flow rate and sample flow rate, as well as the ratio between the two, to reduce or eliminate problems associated with existing systems. There is a need to ensure consistent and predictable delivery of sheath fluid and sample fluid to a flowcell. There is also a need to enable careful calibration between the sheath and sample flows in order to ensure accuracy in analytical flow instrumentation, for instance flow imaging systems.

### BRIEF DESCRIPTION

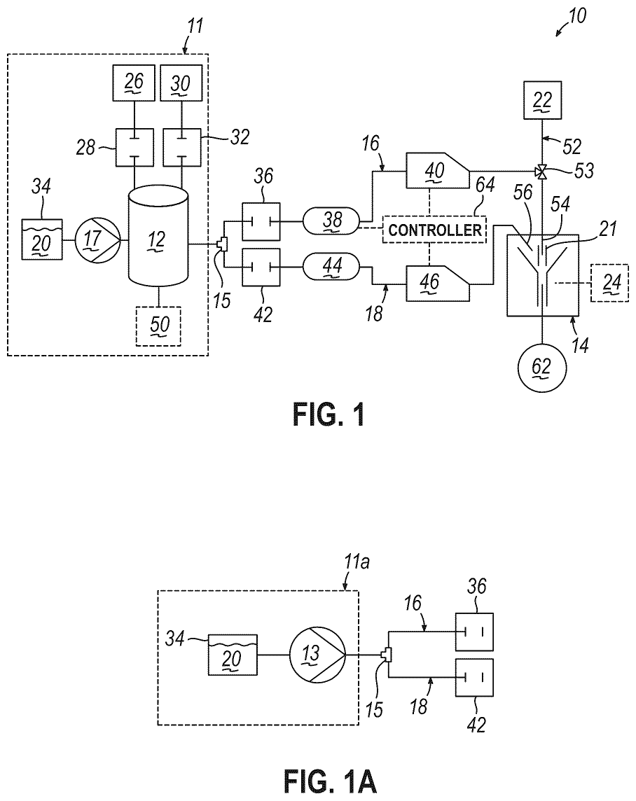

FIG. 1 depicts a schematic view of a first example of a biological analysis system that includes a flow generator;

FIG. 1A depicts an alternative flow generator connected with the biological analysis system of FIG. 1;

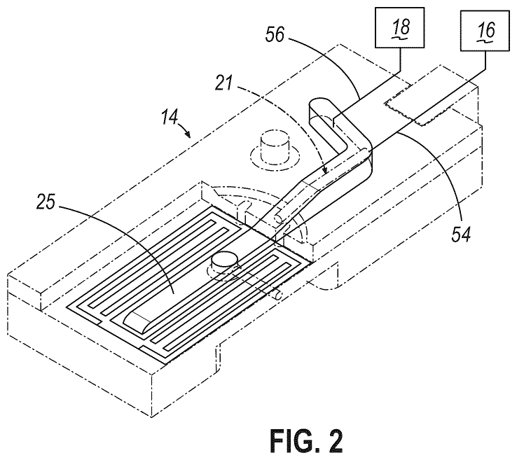

FIG. 2 depicts a perspective view of an exemplary flowcell, shown schematically, for use with the biological analysis system of FIG. 1;

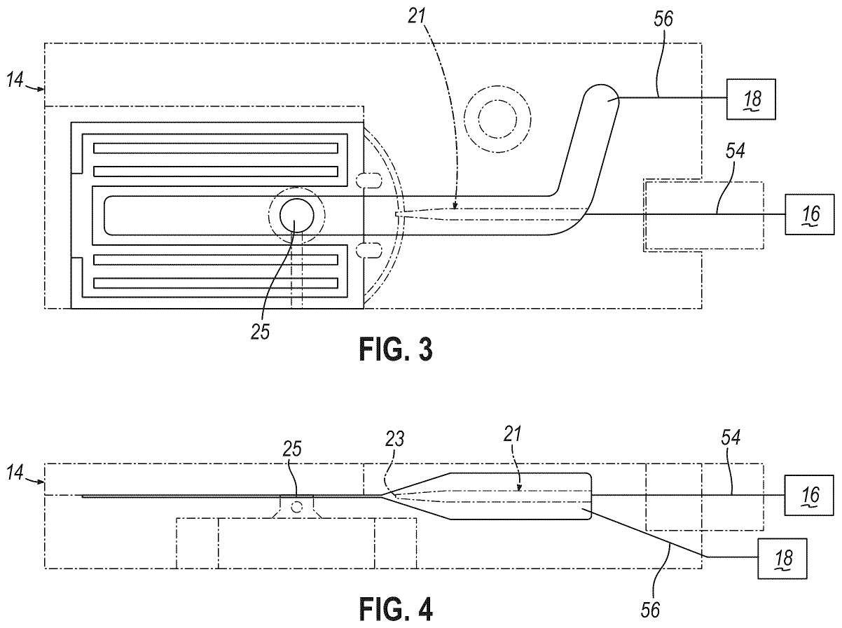

FIG. 3 depicts a top plan view of the flowcell of FIG. 2;

FIG. 4 depicts a side elevational view of the flowcell of FIG. 2;

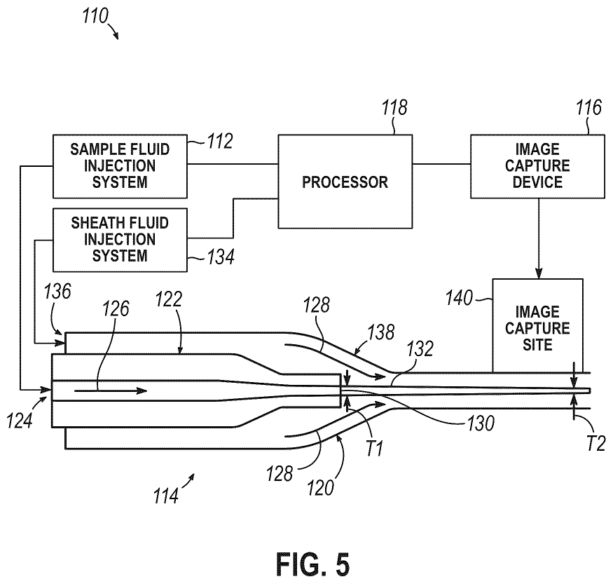

FIG. 5 depicts an exemplary system for imaging particles;

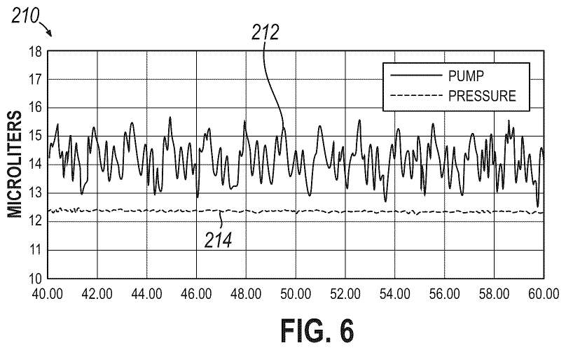

FIG. 6 depicts a graph of exemplary sample flow rates where a first plot includes a system with dual pumps and a second plot includes a system with a single pressurized chamber;

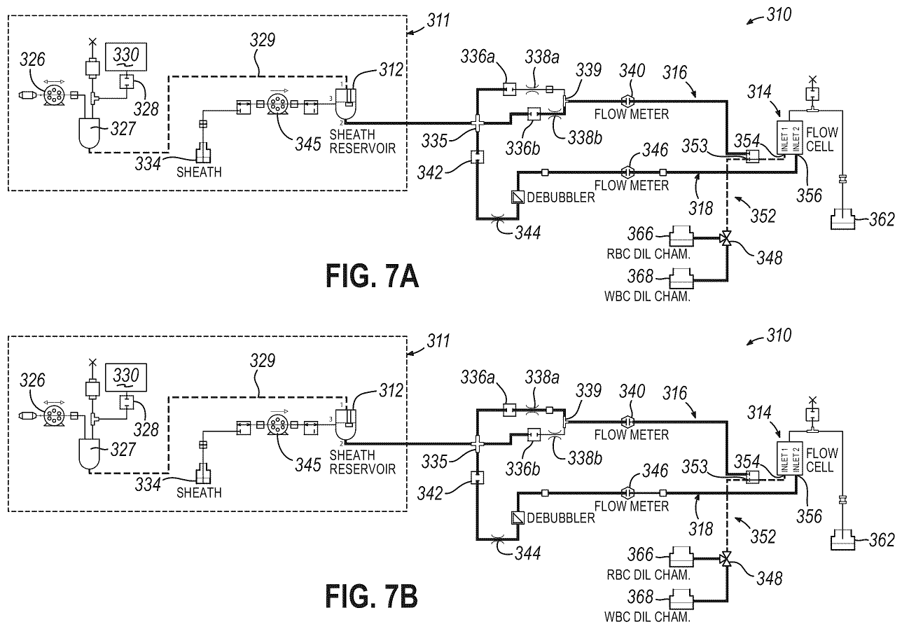

FIG. 7A depicts a schematic view of a second exemplary biological analysis system using a first exemplary circuit;

FIG. 7B depicts a schematic view of the biological analysis system of FIG. 7A but using a second exemplary circuit; and

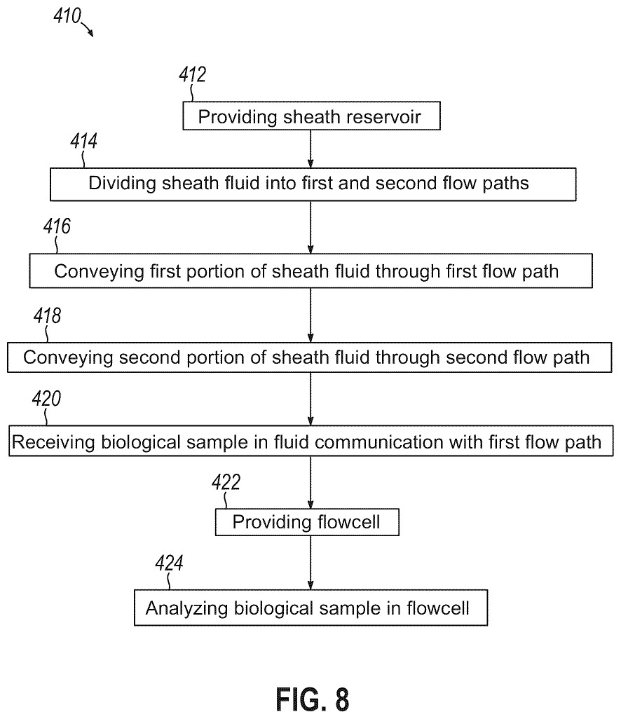

FIG. 8 depicts an exemplary method of analyzing a biological sample using the biological analysis system of FIG. 1.

### SUMMARY

A biological analysis system is described in various embodiments. In some embodiments, the biological analysis system is used to analyze blood. In some embodiments, the biological analysis system is used to analyze other body fluids such as synovial fluid, cerebrospinal fluid, urine, bone marrow aspirate, or other bodily fluids/substances.

In some embodiments, a biological analysis system includes a flow generator, a flowcell, a first flow path, and a second flow path. The flow generator is configured to provide a fluid. The flowcell is configured to receive a biological sample. The first flow path is in fluid communication with the flow generator and configured to receive a first portion of the fluid from the flow generator. The first flow path is configured to convey the biological sample using the first portion to the flowcell at a first flow rate. The second flow path is in fluid communication with the flow generator and configured to receive a second portion of the fluid from the flow generator. The second flow path is configured to convey the second portion to the flowcell at a second flow rate. The second flow rate is different than the first flow rate.

In some embodiments, a biological analysis system includes a reservoir, a first flow path, a second flow path, a biological sample, and a flowcell. The reservoir contains a fluid. The first flow path is configured to receive a first portion of the fluid from the reservoir. The second flow path configured to receive a second portion of the fluid from the reservoir. The biological sample is in fluid communication with the first flow path. The flowcell is configured for analysis of the biological sample. The flowcell includes a first passageway and a second passageway. The first passageway is linked to the first flow path, such that the first portion of the fluid from the first flow path is configured to drive the biological sample from outside the flowcell through the first passageway of the flowcell. The second passageway is linked to the second flow path, such that the second portion of the fluid from the second flow path is configured to be conveyed through the second passageway of the flowcell.

In some embodiments, a blood analysis system includes a reservoir filled with fluid, a first flow path, a second flow path, a blood sample, and a flowcell. The first flow path is configured to receive a first portion of the fluid. The second flow path is configured to receive a second portion of the fluid. The blood sample is in fluid communication with the first flow path. The flowcell is configured for analysis of the blood sample. The flowcell is in fluid communication with the first flow path, such that the first portion of the fluid from the first flow path drives the blood sample from outside the flowcell through the flowcell. The flowcell is in fluid communication with the second flow path, such that the second portion of the fluid is conveyed through the flowcell.

In some embodiments, a biological imaging system includes a sheath fluid, a first flow path, a second flow path, a biological sample, and a flowcell. The first flow path is configured to receive a first portion of the sheath fluid. The second flow path is configured to receive a second portion of the sheath fluid. The biological sample is in fluid communication with the first flow path. The flowcell is configured for imaging of the biological sample. The flowcell is in fluid communication with the first flow path, such that the first portion of the sheath fluid from the first flow path drives the blood sample from outside the flowcell through the flowcell. The flowcell is in fluid communication with the second flow path, such that the second portion of the sheath fluid is conveyed through the flowcell.

In some embodiments, a biological analysis system includes a flow generator configured to provide a fluid, a first flow path in fluid communication with both the flow generator and the flowcell, and a second flow path in fluid communication with both the flow generator and the flowcell. The first flow path is configured to convey a biological sample through an analysis region of the flowcell at a first flow rate. The second flow path is configured to convey a sheath fluid through the analysis region of the flowcell at a second flow rate. The first and second flow rates wherein the first and second flow rates define a ratio, with the ratio being fixed.

In some embodiments, a method of analyzing a biological sample includes providing a sheath reservoir containing a sheath fluid. The method also includes dividing the sheath fluid into first and second flow paths that are linked with the sheath reservoir. The method also includes conveying a first portion of the sheath fluid through the first flow path. The method also includes conveying a second portion of the sheath fluid through the second flow path. The method also includes receiving a biological sample in fluid communication with the first flow path. The method also includes providing a flowcell configured for analysis of the biological sample, the flowcell including a first passageway and a second passageway, wherein the first passageway is linked to the first flow path such that the first portion of the sheath fluid drives the biological sample from outside the flowcell through the first passageway of the flowcell, and the second passageway is linked to the second flow path such that the second portion of the sheath fluid is conveyed through the second passageway of the flowcell.

In some embodiments, a method of analyzing a biological sample includes dividing a fluid, obtained from a flow generator, into a first flow path that contains a first portion of the fluid and a second flow path that contains a second portion of the fluid. The method also includes conveying a biological sample using the first portion of the fluid along the first flow path to a flowcell at a first flow rate. The method also includes conveying the second portion of the fluid to the flowcell at a second flow rate, wherein the second flow rate is different than the first flow rate. The method also includes analyzing the biological sample within the flow cell.

### DETAILED DESCRIPTION

The present disclosure relates to apparatus, systems, compositions, and methods for analyzing biological samples. Various exemplary biological analysis systems (10, 310) will be described in greater detail with reference to FIGS. 1-4 and FIGS. 7A-7B.

### A. First Exemplary Biological Analysis System

FIG. 1 shows a first exemplary biological analysis system (10) that includes, among other components, a flow generator (11), and a flowcell (14). The flow generator (11) is shown as a pressure-based flow generator that includes a sheath reservoir (12), which is shown as being pressurized. A pressure based flow generator may be sensitive to viscosity and pressure. The sheath reservoir (12) of the flow generator (11) is configured to provide a sheath fluid at a bulk flow rate to first and second flow paths (16, 18). While the sheath reservoir (12) is shown and described as containing sheath fluid (20), a variety of fluids other than sheath fluid may be contained within sheath reservoir (12), including but not limited to a diluent. The sheath reservoir (12) may be referred to as the single common reservoir/chamber, as in the system (10) of FIG. 1, a single sheath reservoir (12) feeds each of the first and second flow paths (16, 18) without an additional sheath reservoir.

In one version, a float may be used determine the volume of sheath fluid (20) in sheath reservoir (12) (e.g., sheath fluid (20) is filled up to the float). In other versions, the volume may be set electronically. In other versions, the volume is customized depending on the sample analysis. For instance, the volume of the sheath fluid (20) in the sheath reservoir (12) may be adjusted to allow for extended imaging times as desired for low density samples, such as body fluids. The measurable cells in body fluids may be less dense than in a blood sample, and in this way, may be referred to as having a lower density. As such, a larger volume of a sample of body fluids may be processed to determine the cellular material located in the sample, which may entail longer/extended imaging times. In one version, the volume of sheath fluid (20) in sheath reservoir (12) may be about 100-200 mL, or about 150 mL. In one example, a cycle utilizes about 3 mL of sheath fluid, so a 150 mL reservoir of sheath fluid may last for about 50 cycles (e.g., before the reservoir needs to be refilled via a sheath fluid supply—in a scenario where it is not being refilled as it is being pumped out). In this example, assuming a 1 minute cycle, the reservoir would last for about 50 minutes. In some embodiments, a reservoir may be refilled with sheath fluid from a sheath fluid supply as the sheath fluid as being pumped out such that, for instance, there is a relatively constant supply of sheath fluid in the reservoir or such that the sheath fluid in the reservoir is refilled from a sheath fluid supply once it drops below a particular volume (e.g., 25 or 50 mL).

As shown in FIG. 1, the flow generator (11) additionally includes an air compressor (26), an air compressor valve (28), an air vent (30), and an air vent valve (32) which are in communication with a sheath fluid supply (34) that contains the sheath fluid (20). Examples of sheath fluids are described in U.S. Pat. No. 9,316,635, entitled “Sheath Fluid Systems and Methods for Particle Analysis in Blood Samples,” issued Apr. 19, 2016, the disclosure of which is incorporated by reference herein, in its entirety. The air compressor (26) is positioned upstream of the compressor valve (28) which is positioned upstream of the sheath fluid supply (34). In some versions, pressure to the sheath reservoir (12) may be increased using air from an air compressor or using a pump to increase the amount of sheath fluid (20) contained within the sheath reservoir (12). The air vent (30) is positioned upstream of the air vent valve (32), which is positioned upstream of the sheath reservoir (12). A pump (17) connects the sheath fluid supply (34) with the sheath reservoir (12) to supply fluid from the sheath fluid supply (34) to the sheath reservoir (12). A T-junction (15) is positioned between the outlet of the sheath reservoir (12) and first and second flow path valves (36, 42).

The sheath reservoir (12) maintains the sheath fluid (20) at a desired pressure. For example, the sheath reservoir (12) may include a pressure tank where a gas (e.g., air) is selectively introduced into or removed from the pressure tank to maintain the pressure tank at the desired pressure. In some versions, the pressure of sheath fluid (20) within sheath reservoir (12) is between about 8 and about 30 pounds per square inch of pressure. In some versions, an optional pressure sensor (50) may be incorporated to monitor the pressure in the sheath reservoir (12). Software may monitor the pressure in the sheath reservoir (12) and/or output flow through the first and second flow paths (16, 18) and adjust the flow rate by increasing pressure or reducing pressure to the sheath reservoir (12). For example, the pressure of the sheath reservoir (12) may be increased by activating the compressor (26) and opening the compressor valve (28) so that compressed air from the compressor (26) flows through compressor valve (28) and into the sheath reservoir (12). Conversely, the pressure of the sheath reservoir (12) may be reduced by opening the air vent valve (32) so that air from the sheath reservoir (12) flows out through the air vent (30).

FIG. 1A shows an example of an alternative flow generator (11a), which does not utilize a sheath reservoir/tank (12). The flow generator (11a) utilizes a pump or hydraulic flow generator. The flow generator (11a) includes a metering pump or a gear pump (13), and a sheath fluid supply (34) that contains the sheath fluid (20). Similar to FIG. 1, a T-junction (15) is positioned between the outlet of the pump (13) and first and second flow path valves (36, 42). Pump (13) pulls liquid from sheath fluid supply (34) and provides the sheath fluid (20) to the first and second flow paths (16, 18). Various other pumps or hydraulic features may also be included.

Flow generator (11, 11a) is linked to (e.g., in fluid communication with) the first flow path (16) and the second flow path (18) such that the sheath fluid (20) passes through the first flow path (16) and the second flow path (18). In other words, a first portion of the sheath fluid (20) from the flow generator (11, 11a) is conveyed at the bulk flow rate at a first pressure to the first flow path (16). Similarly, a second portion of the sheath fluid (20) from the flow generator (11, 11a) is conveyed at the first pressure and at the bulk flow rate to the second flow path (16). Separating the output of flow generator (11, 11a) into first and second flow paths (16, 18) allows the flow generator (11, 11a) to create both the sample flow (using the first flow path (16)) and the sheath flow (using the second flow path (18)). The first flow path (16) and the second flow path (18) are disposed between flow generator (11, 11a) and the flowcell (14).

The first flow path (16) is configured to convey the biological sample using the first portion to the flowcell (14) at a first flow rate. The second flow path (18) is configured to convey the second portion to the flowcell (14) at a second flow rate that is different than the first flow rate. In one version, the biological analysis system (10) is configured such that the sheath fluid flow rate through the second flow path (18) is faster or higher than the sheath flow rate through the first flow path (16).

The first flow path (16) includes a first flow path valve (36) positioned upstream of a first flow restrictor (38), which is positioned upstream of an optional first flow rate sensor (40). In other words, the first flow restrictor (38) and the first flow rate sensor (40) are positioned along the first flow path (16). Similar to the first flow path (16), the second flow path (18) includes a second flow path valve (42) positioned upstream of a second flow restrictor (44), which is positioned upstream of an optional second flow rate sensor (46). In other words, the second flow restrictor (44) and the second flow rate sensor (46) are positioned along the second flow path (18). In one example, the first and second flow path valves (36, 42) have an on/off or open/closed configuration which either allow or prevent flow therethrough. A variety of suitable valves may be used including pinch valves and/or rocker valves. In one version, the first and second flow path valves (36, 42) are configured to be in a closed position unless the analysis circuit/module is in an activated mode, in which case, the flow path valves (36, 42) adopt an open position.

The first and second flow restrictors (38, 44) maintain a constant ratio of biological sample flow rate to sheath flow rate. This ratio is constant because the first and second flow restrictors (38, 44) are fed by the same sheath fluid (20) coming from the same sheath source (e.g., sheath reservoir (12) in FIG. 1 or sheath fluid supply (34)/gear pump (13) in FIG. 1A). In other words, since a single fluid source (i.e., sheath fluid (20)) drives the entire biological analysis system (10), any changes of pressure, temperature, or viscosity impact each flow path (16, 18) equally. In this way, the sample to sheath flow rate ratio is constant and independent of pressure, temperature, and viscosity. This constant ratio may be beneficial in the context of an analysis system, including in an imaging analysis system or flow imaging analysis system utilizing discrete sample imaging. The constant ratio ensures quantitative control over the biological analysis system (10). For example, quantitative control of platelet count is beneficial for hematology applications. The constant ratio maintains a constant thickness of the sample ribbon/stream, which ensures the same imaged volume independent of the actual flow rates (which might change based on temperature, pressure changes etc.) Variations in ribbon thickness may cause undercounting or undercounting.

The first flow restrictor (38) controls the sheath fluid flow rate through first flow path (16) which drives sample flow through flowcell (14). The second flow restrictor (44) controls the sheath fluid flow rate through second flow path (18) which drives the sheath fluid through flowcell (14) and surrounds the sample flow through the analysis region of flowcell (14). The first and second flow restrictors (38, 44) may be positioned on the input tubing to the flowcell (14). The first and second flow restrictors (38, 44) may be selected based on the desired flow rate and the pressure of the sheath reservoir (12). For example, the first and second flow restrictors (38, 44) may have a smaller inner diameter compared to the rest of the output tubing. In other words, the maximum inner diameter of the first and second flow restrictors (38, 44) is less than the respective minimum inner diameter of the first and second flow paths (16, 18). In some versions, the first flow restrictor (38) may be about 2 inches to about 1 foot in length and have an inner diameter of about 0.002 to about 0.01 inches. In some versions, the second flow restrictor (44) may be about 1 foot to about 4 feet in length and have an inner diameter of about 0.01 to 0.04 inches. In one example, the first flow restrictor (38) may be about 6 inches in length and have an inner diameter of about 0.004 inches, and the second flow restrictor (44) may be about 2 feet in length and have an inner diameter of about 0.02 inches. In one version, components forming first and second flow paths (16, 18) comprise polymer (e.g., PEEK or PTFE) tubing. First flow path (16) may comprise a polymer tubing with an inner diameter of about 0.01-0.04 inches, or about 0.02. First flow restrictor (38) may be configured as an internal tubing configured within the first flow path (16) tubing, for instance an internal tubing coupled via threads or barbs within a portion of first flow path (16). Second flow path (18) may comprise a polymer tubing with an inner diameter of about 0.02 to about 0.06 inches, or about 0.04 inches. Second flow restrictor (44) can, similar to first flow restrictor (38), be configured as an internal tubing, for instance an internal tubing coupled via threads or barbs within a portion of second flow path (18).

The optional first and second flow rate sensors (40, 46) sense the respective first and second flow rates of the first and second flow restrictors (38, 44). The optional first and second flow rate sensors (40, 46) may also monitor and flag potential issues (e.g., air bubbles). Air bubbles reaching the flowcell (14) may disturb the sample stream and affect image quality. The optional first and second flow rate sensors (40, 46) may monitor the sheath and sample flow rates in real-time. While the first and second flow rate sensors (40, 46) may include a variety of suitable flow rate sensors, one such suitable example is the SLF series, commercially available from Sensirion. The first and second flow rate sensors (40, 46) may be positioned at different locations and may passively monitor the respective first and second flow paths (16, 18). For instance, the first and second flow rate sensors (40, 46) are positioned relatively close and downstream of first and second flow restrictors (38, 44), but may be positioned at any location downstream of T-junction (15). As shown, the first and second flow rate sensors (40, 46) are positioned downstream of first and second flow restrictors (38, 44).

Optionally, a controller (64) may be operatively connected with biological analysis system (10) to automatically control one or more aspects of biological analysis system (10). For example, as shown in FIG. 1, the controller (64) may be operatively connected with the first flow restrictor (38), the second flow restrictor (44), the first flow rate sensor (40), and/or the second flow rate sensor (46). In some versions, controller (64) may be used to control actions of first and second flow restrictors (38, 44) in an automated system. For instance, first and second flow restrictors (38, 44) may be configured as selectively and automatedly adjustable to set a particular flow rate (e.g., via a programmable inner diameter, or a localized pump at/near the flow restrictor section) to dynamically set a particular flow rate in each flow path (16, 18). For instance, the controller (64) may monitor sheath flow rates through each flow path (16, 18), and associated sheath fluid ratios within each flow path (16, 18) after passing through restrictors (38, 44). The controller (64) may flag a sample or shut down operations if the ratio falls outside of predetermined range (e.g., based on one or more signals from first and second flow rate sensors (40, 46). In one example, this is performed in a dynamic manner where flow rate is consistently monitored, and adjustments are dynamically made to the system to maintain a particular optimal flow rate. Controller (64) may provide continuous data monitoring. In other versions, the first flow restrictor (38) and/or the second flow restrictor (44) are not controlled by the controller (64). Instead, the first flow restrictor (38) controls the flow rate of the first flow path (16) and the second flow restrictor (38) controls the flow rate of the second flow path (16) to the flowcell (14) passively, without active control by the controller (64).

The biological analysis system (10) is configured to analyze a biological sample (22). In versions where the biological analysis system (10) images a biological material, the biological analysis system (10) may be referred to as a biological imaging system. For example, the biological analysis system (10) may include an imaging device (24) configured to create discrete images of the biological sample (22) (e.g., blood cells) as the biological sample (22) passes through the flowcell (14). For example, the imaging device (24) may include a high-speed, high-resolution camera configured to take discrete snapshots as compared to a continuous detection system that may assess light scatter. In some versions, the biological sample (22) includes a blood sample. In versions where the biological analysis system (10) analyzes a blood sample, the biological analysis system (10) may be referred to as a blood analysis system. While analysis and imaging of blood is shown and described herein, the biological analysis system (10) may analyze (and optionally image) a variety of fluids including, but not limited to, other body fluids such as synovial fluid, urine, bone marrow aspirate, etc.

The biological sample (22) is in fluid communication with a biological sample valve (53) and is configured to enter the first flow path (16) along an initial biological sample flow path (52) prior to being introduced into the first flow path (16). Biological sample valve (53), shown as a three way valve in one embodiment, helps convey the biological sample (22) from an area outside of the flowcell circuit to the flowcell circuit, whereupon biological sample (22) may be conveyed along a portion of the first flow path (16) by the sheath fluid (20). An external pressure source (e.g., air, syringe pump, or other means) (not shown in FIG. 1) positioned upstream from the biological sample valve (53) may be configured to convey the biological sample (22). Once the biological sample (22) is past or downstream of the biological sample valve (53), sheath fluid (20) in the first flow path (16) drives the biological sample (22) toward the flowcell (14). Sheath fluid (20) is proximal of or in an upstream direction relative to the biological sample (22), and as such, is configured to drive the biological sample (22) toward flowcell (14).

Flowcell (14) utilizes a hydrodynamic principle where a biological sample (22) is accelerated and stretched into a thin stream and surrounded by a sheath fluid (20) delivered through second flow path (18) to be analyzed within an analysis region (25) of the flowcell (14). The flow rate of sheath fluid (20) is generally faster than the flow rate of biological sample (22) because the cross section of the sheath channel is much larger than the sample/cannula. The linear velocity of the sheath fluid (20) may be the same or higher than the flow rate of biological sample (22) at the exit point (23) (see FIGS. 2-4) of the cannula (21). As shown in FIG. 1, the sheath fluid (20) drives flow of the biological sample (22) through the first flow path (16) into the cannula (21) positioned in flowcell (14). The first flow restrictor (38) along the first flow path (16) is configured to cause a lower flow rate than the second flow restrictor (44) along the second flow path (18), so that the first flow rate of the sheath fluid (20) through the first flow path (16) is less than the second flow rate of the sheath fluid (20) through the second flow path (18).

As shown schematically in FIG. 1 and in greater detail in FIGS. 2-4, the flowcell (14) is configured to analyze the biological sample (22). The flowcell (14) includes a first passageway (54) and a second passageway (56). The first passageway (54) is linked to the first flow path (16), and the second passageway (56) is linked to the second flow path (18). The second portion of the sheath fluid from the second flow path (18) may be referred to as a sheath source that surrounds the biological sample (22) through the flowcell (14). The first portion of the sheath fluid from the first flow path (16) may physically push the biological sample (22), such that the biological sample (22) is surrounded by the sheath source (e.g., second portion of the sheath fluid) upon the biological sample (22) exiting the cannula (21). After exiting the cannula (21), the sample fluid stream merges and/or is surrounded with sheath fluid stream at a pre-imaging region. In the pre-imaging region, the sample fluid stream becomes sandwiched by the sheath fluid stream prior to proceeding downstream to the analysis region (25) of the flowcell (14). The imaging device (24) may image the biological sample (22) in the analysis region (25) of the flowcell (14). For example, a blood sample may be surrounded by sheath fluid to ensure proper alignment of blood particles during imaging. Additional examples of flowcells and examples of hydrodynamic focusing (where the flowcell geometry narrows the sample fluid flow and the sheath fluid flow for imaging) are described in U.S. Pat. No. 9,316,635, entitled “Sheath Fluid Systems and Methods for Particle Analysis in Blood Samples,” issued Apr. 19, 2016, the disclosure of which is incorporated by reference herein, in its entirety and U.S. Pat. No. 9,322,752, entitled “Flowcell Systems and Methods for Particle Analysis in Blood Samples,” issued Apr. 26, 2016, the disclosure of which is incorporated by reference herein, in its entirety.

Alternative embodiments may utilize additional devices besides flow restrictors to create a certain flow rate within each flow path. The inclusion of a common sheath reservoir (12) supplying a common sheath fluid to drive both sample flow and sheath flow, as described above, results in a constant fixed ratio between the sample and sheath flow.

### B. Exemplary System for Imaging Particles

FIG. 5 shows aspects of a system (110) for imaging particles in a blood fluid sample. System (110) may be used in place of imaging device (24) of FIG. 1. As shown, the system (110) includes a sample fluid injection system (112), a flowcell (114) which may be similar to flowcell (14), and an image capture device (116), and a processor (118). The flowcell (114) provides a flowpath (120) that transmits a flow of the sheath fluid, optionally in combination with the sample fluid. According to some embodiments, the sample fluid injection system (112) can include a cannula or injection tube (122) positioned before (i.e., upstream of) the image capture site (140). The sample fluid injection system (112) can be in fluid communication with the flowpath (120) (e.g., via sample fluid entrance (124), and can operate to inject sample fluid (126) through a distal exit port (130) of the injection tube (122) and into a flowing sheath fluid (128) within the flowcell (114) so as to provide a sample fluid stream (132), also referred to as a ribbon. For example, the processor (118) may include or be in operative association with a storage medium having a computer application that, when executed by the processor, is configured to cause the sample fluid injection system (112) to inject sample fluid (126) into the flowing sheath fluid (128).

As shown, sheath fluid (128) may be introduced into the flowcell (114) by a sheath fluid injection system (134) (e.g., via sheath fluid entrance (136). For example, the processor (118) may include or be in operative association with a storage medium having a computer application that, when executed by the processor, is configured to cause the sheath fluid injection system (134) to inject sheath fluid (128) into the flowcell (114). As depicted in FIG. 5, the distal exit port (130) of injection tube (122) can be positioned at a central location along the length of the narrowing transition zone (138). In some cases, the distal exit port (130) can be positioned more closely to the beginning (proximal portion) of the transition zone (138). In some cases, the distal exit port (130) can be positioned more closely to the end (distal portion) of the transition zone (138). In some cases, the distal exit port (130) can be positioned entirely outside of the transition zone (138) (where distal exit port (130) is disposed proximal to the narrowing transition zone).

With continued reference to FIG. 5, the sample fluid stream (132) has a first thickness T1 at the exit port (130). The flowpath (120) of the flowcell having a decrease in flowpath size such that the thickness of the sample fluid stream (132) decreases from the initial thickness T1 to a second thickness T2 adjacent an image capture site (140). The sample fluid (126) exits the exit port (130) where it merges and/or is surrounded with sheath fluid (128) at a pre-imaging region. In the pre-imaging region, the sample fluid stream (132) becomes sandwiched by the sheath fluid (128) prior to proceeding downstream to the image capture site (140) which is the imaging region. The image capture device (116) is aligned with the image capture site (140) so as to image a first plurality of the particles from the first sample fluid at the image capture site (140) of the flowcell (114).

The processor (118) is coupled with the sample fluid injection system (112), the image capture device (116), and optionally the sheath fluid injection system (134). The processor (118) is configured to terminate injection of the first sample fluid into the flowing sheath fluid (128) and begin injection of the second sample fluid into the flowing sheath fluid (128). For example, the processor (118) may include or be in operative association with a storage medium having a computer application that, when executed by the processor, is configured to cause the sample fluid injection system (112) to inject the second sample fluid into the flowing sheath fluid (128).

Further, the processor (118) is configured to initiate capture of an image of a second plurality of the particles from the second sample fluid at the image capture site (140) of the flowcell (114) after the sample fluid transients. For example, the processor (118) may include or be in operative association with a storage medium having a computer application that, when executed by the processor, is configured to cause the image capture device (116) to initiate capture of an image a second plurality of the particles from the second sample fluid at the image capture site (140) of the flowcell (114) after the sample fluid transients and the imaging of the first plurality the particles.

Accordingly, embodiments of the present invention encompass a system (110) for imaging a plurality of particles in a sample fluid (126) having a sample fluid viscosity. The system (110) can include a flowcell (114) having a flowpath (120) and injection tube (122). The flowpath (120) can have a reduction in flowpath size or narrowing transition zone. Further, the system (110) can include a sheath fluid entrance (136) in fluid communication with the flowpath (120) of the flowcell (114) so as to transmit a flow of the sheath fluid along the flowpath (120) of the flowcell (114). The system (110) can also include a sample fluid entrance (124) in fluid communication with the injection tube (122) of the flowcell (114) so as to inject a sample fluid stream (132) of the blood fluid sample into the flowing sheath fluid within the flowcell (114). For example, the sample fluid (126) can exit the distal exit port (130) of the injection tube (122) and into an envelope of the flowing sheath fluid (128) to form a sample ribbon (132) therein.

The sheath fluid (128) along with the sample fluid ribbon (132), formed from the sample fluid (126), flows through the transition zone (138) in flowpath size and toward a pre-imaging region, and then to an imaging site/imaging region (140). As shown, the system (110) also includes an imaging device (116) that images the plurality of particles at the imaging site (140).

### C. Exemplary Graph of Sample Flow Rate

FIG. 6 shows a graph (210) of exemplary sample flow rate that includes a first plot (212) of a system with dual pumps and a second plot (214) of a system with a single chamber (e.g., sheath reservoir (12)). An exemplary sample flow rate for a system with a single chamber (e.g., sheath reservoir (12)) may be about 6-24 microliters per minute, or about 10-14 microliters per minute. For example, this may correspond to a sheath flow rate downstream of first flow restrictor (38) through first flow path (16), as this circuit drives the sample. As shown, there is greater consistency in the second plot (214) than the first plot (212). It may be beneficial to reduce the variability in the first plot (212). For example, the inconsistency of sample flow rate of the first plot (212), which represents a dual pump system, may cause data noise and may cause issues in the analysis region (25) of flowcell (14), for instance with a flow imaging system where changes in flow rate could negatively impact image focus (e.g., a thicker ribbon may cause smaller particles such as platelets to be less focused). By contrast, the consistency of sample flow rate of second plot (214) minimizes noise and can have advantages, for instance, in a flow imaging system by promoting consistent image focusing. When the flow rate varies, the thickness of the ribbon varies by the same relative amount. Conversely, the more stable the flow rate, the more consistent ribbon thickness which improves quantitative results.

FIG. 6 shows an exemplary graph. In some examples, the sample flow rate is about 6-24 microliters/minute and the sheath flow rate is about 2600-3000 microliters/minute. In some versions, analysis of white blood cells (WBC) and red blood cells (RBC) may utilize a sheath flow rate of about 3,000 microliters per minute. As will be described with reference to FIGS. 7A-7B, in some examples, an analysis system (10) utilizes a first analysis regimen or circuit for red blood cells, and a second analysis regimen or circuit for white blood cells (e.g., where blood used for each analysis regimen or circuit is stored in different chambers to provide separate samples (22)), where the flow rates for each sample type is different. For example, a red blood cell sample may flow at about 6-12 microliters/minute and a white blood cell sample may flow at about 14-22 microliters/minute. In some examples, a ratio between sheath and sample flow rates (i.e., sheath flow rate divided by sample flow rate) is about 150-500, about 200-400, or about 200-250. The controller (64) may be utilized to monitor the sheath flow rate, sample flow rate, and ratio between the two and flag results if outside a certain range (e.g., outside of a 5-10% threshold from a predetermined ideal ratio). The ratio and corresponding threshold may be different for different samples (e.g., a red blood cell sample, a white blood cell sample, a body fluid sample). In some versions, analysis of the red blood cell sample may utilize a sample flow rate of about 8 microliters/minute and analysis of the white blood cell sample may utilize a sample flow rate of about 14 microliters/minute. The lower comparative sample flow rate for the red blood cell sample as compared to the white blood cell sample may be used to prevent sample fluid containing red blood cells from moving out of focus when analyzing the red blood cell sample. For diluted body fluids, a greater collection duration may be used to obtain additional data.

### D. Second Exemplary Biological Analysis System

FIGS. 7A-7B show a second exemplary biological analysis system (310). The biological analysis system (310) may include similar components to systems (10, 110). While biological analysis system (310) is shown as including a flow generator that includes a sheath reservoir (312), biological analysis system (310) may include a pump based flow generator similar to flow generator (11a) shown in FIG. 1A. The sheath reservoir (312) may be similar to the sheath reservoir (12), a flowcell (314) may be similar to the flowcell (14), a first flow path (316) may be similar to the first flow path (16), a second flow path (318) may be similar to the second flow path (18), and a sheath fluid (not shown) may be similar to the sheath fluid (20). As will be described in greater detail below, the fluid path of the first flow path (316) is different in comparing FIG. 7A to FIG. 7B. The biological analysis system (310) includes a valve (328) that may be similar to the valve (28) and an air vent (330) that may be similar to the air vent (30).

A sheath fluid supply (334), which may be similar to the sheath fluid supply (34), supplies sheath fluid (20) to the sheath reservoir (312) using a pump (345). A pump (326), such as a peristaltic pump, and a pressure chamber (327) may pressurize the sheath reservoir (312). The sheath reservoir (312) is linked to (e.g., in fluid communication with) the first flow path (316) and the second flow path (318), such that sheath fluid (20) from the sheath reservoir (312) passes through at least the first flow path (316) and the second flow path (318). An air pathway (329) is shown using a dashed line between the pressure chamber (327) and the sheath reservoir (312). In some embodiments, the air may be pressurized to allow pressure generated in the pressure chamber (327) to be transferred to the sheath reservoir (312). For example, the pressure of the air pathway (329) may be about 8 psi of air pressure.

Downstream of the sheath reservoir (312), the biological analysis system (310) includes a junction (335), valves (336a, 336b, 342), first, second, and third flow restrictors (338a, 338b, 344), optional first and second flow meters (340, 346), and a valve (353). Junction (335) may be used to divide the sheath fluid. The first, second, and third flow restrictors (338a, 338b, 344) may be similar to the first and second flow restrictors (38, 44). Similarly, the optional first and second flow meters (340, 346) may be similar to the first and second flow rate sensors (40, 46), and valve (353) may be similar to valve (53). The biological analysis system (310) includes first and second dilution chambers, which are shown as a red blood cell dilution chamber (366) and a white blood cell dilution chamber (368). The red and white blood cell dilution chambers (366, 368) are in communication with a biological sample fluid path (352) using a three way valve (348). While not shown, fluid from red and white blood cell dilution chambers (366, 368) may be advanced using sheath fluid. The biological sample fluid path (352) is introduced with the first flow path (316) using the valve (353). In some versions, a biological sample fluid path (352) may terminate into valve (353) with a separate fluid connection disposed between valve (353) and the first passageway (354).

The flowcell (314) includes a first passageway (354) that may be similar to the first passageway (54) and a second passageway (356) that may be similar to the second passage (56). The biological sample fluid path (352) is shown using a dashed line that terminates into valve (353), which may be fluidly connected with the first passageway (354) of flowcell (314). While not shown, the biological analysis system (310) may include an imaging device similar to the imaging device (24) or the system (110). Downstream of the flowcell (314) is a waste (262) that may be similar to the waste (62). While not shown, the biological analysis system (310) may include an optional controller, similar to controller (64) (see FIG. 1) to control one or more components of the biological analysis system (310).

FIG. 7A shows a schematic view of the biological analysis system (310) using a first exemplary circuit, and FIG. 7B shows a schematic view of the biological analysis system of FIG. 7A but using a second exemplary circuit. The difference between FIGS. 7A and 7B are illustrated between valve (336a) and fitting (339) as well as valve (336b) and fitting (339). As shown in FIG. 7A, valve (336a) is closed and valve (336b) is open. As a result, for FIG. 7A, the fluid in the first flow path (316) travels through the valve (336b), the second flow restrictor (338b), a fitting (339), and the optional first flow meter (340), and not through the first flow restrictor (338a). As shown in FIG. 7B, valve (336a) is open and valve (336b) is closed. As a result, for FIG. 7B, the fluid in the first flow path (316) travels through the valve (336a), the first flow restrictor (338a), the fitting (339), and the optional first flow meter (340), and not through second flow restrictor (338b). The sizing of the first and second flow restrictors (338a-b) may allow for the flowrate of the first flow path (316) in FIG. 7A to be different from flowrate of the first flow path (316) in FIG. 7B.

Each patient sample may be imaged using the first and second circuits of FIGS. 7A-7B. For example, the first circuit may include a red blood cell circuit (RBCC), and the second circuit of FIG. 7B may include a white blood cell circuit (WBCC). For red blood cell imaging, the RBCC of FIG. 7A may be utilized. Similarly, for white blood cell imaging, the WBCC of FIG. 7B may be utilized. For example, using the RBCC, the sample may be imaged for as short as about 1 second. Similarly, for example, using the WBCC, the sample may be imaged for as short as about 10 seconds, or even as short as about 5 seconds. A first flowrate of the first flow path (316) may be used for white blood cells received from the biological sample fluid path (352), and a second flowrate of the first flow path (316) may be used for red blood cells received from the biological sample fluid path (352). In FIG. 7A, first flow path (316) may have a flowrate of about 8 microliters/minute. In FIG. 7B, the first flow path (316) may have a flowrate of about 14 microliters/minute. In FIGS. 7A-7B, the second flow path (318) may have a flowrate of about 3,000 microliters/minute.

### E. Exemplary Method of Analyzing a Biological Sample

In FIG. 8, an exemplary method (410) of analyzing a biological sample (22) using the biological analysis systems (10, 310) is also described with reference to FIG. 7A-7B. The method (410) may include steps (412, 414, 416, 418, 420, 422, 424). At step (412), the method (410) includes providing the flow generator (11, 11a, 311) configured to provide the sheath fluid (20) at the bulk flow rate. Flow generator (11, 11a, 311) may include a pump (13) or a pressurized sheath reservoir (12, 312). At step (414), the method (410) includes dividing the sheath fluid (20) obtained from flow generator (11, 11a, 311) into first and second flow paths (16, 18, 316, 318) that are linked with the flow generator (11, 11a). The first flow path (16, 316) contains a first portion of the sheath fluid (20) and a second flow path (18, 318) contains a second portion of the sheath fluid (20).

At step (416), the method (410) includes conveying the first portion of the sheath fluid (20) through the first flow path (16, 316). For example, the biological sample may be conveyed using the first portion of the sheath fluid (20) along the first flow path (16, 316) to the flowcell (14, 314) at the first flow rate. At step (418), the method (410) conveying the second portion of the sheath fluid (20) through the second flow path (18, 318) at a second flow rate that is different than the first flow rate. In some versions, the first flow rate may be obtained using a flow restrictor (38, 338a-b) positioned along the first flow path (16, 316). Similarly, in some versions, the second flow rate may be obtained using flow restrictor (44, 344) positioned along the second flow path (18, 318).

At step (420), the method (410) includes receiving the biological sample in fluid communication with the first flow path (16, 316). At step (422), the method (410) includes providing the flowcell (14, 314) configured for analysis of the biological sample (22). The flowcell (14, 314) includes the first passageway (54, 354) and the second passageway (56, 356). The first passageway (54, 354) is linked to the first flow path (16, 316) such that the sheath fluid (20) drives the biological sample (22) from outside the flowcell (14, 314) through the first passageway (54, 354) of the flowcell (14, 314). The second passageway (56, 356) is linked to the second flow path (18, 318) such that the second portion of the sheath fluid (20) is conveyed through the second passageway (56, 356) of the flowcell (14, 314). At step (424), method (410) includes analyzing the biological sample (22) in the flowcell (14, 314). In some versions, this analysis may include imaging the biological sample (22) in the flowcell (14, 314) using the imaging device (24) (see FIG. 1) or the system (110) (see FIG. 5). The method may also include at least partially surrounding the biological sample (22) using the second portion of the sheath fluid (20).

All patents, patent publications, patent applications, journal articles, books, technical references, and the like discussed in the instant disclosure are incorporated herein by reference in their entirety for all purposes.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention. Accordingly, the present invention is not limited to the embodiments described above or depicted in the drawings, and various embodiments and modifications can be made without departing from the scope of the claims below.

What is claimed is:

1. A biological analysis system comprising:
a flow generator configured to provide a fluid;
a flowcell configured to receive a biological sample;
a first flow path in fluid communication with the flow generator and configured to receive a first portion of the fluid from the flow generator, wherein the first flow path is configured to convey the biological sample using the first portion to the flowcell at a first flow rate; and
a second flow path in fluid communication with the flow generator and configured to receive a second portion of the fluid from the flow generator, wherein the second flow path is configured to convey the second portion to the flowcell at a second flow rate, wherein the second flow rate is different than the first flow rate.

2. The biological analysis system of claim 1, wherein the flow generator is configured to provide the fluid at a bulk flow rate, wherein the first flow path is configured to receive the first portion of the fluid at the bulk flow rate, wherein the second flow path is configured to receive the second portion of the fluid at the bulk flow rate.

3. The biological analysis system of claim 1, wherein the flow generator is a pressure-based flow generator that includes a pressurized reservoir configured to produce the bulk flow rate at a first pressure, and wherein the pressurized reservoir contains the fluid at the first pressure.

4. The biological analysis system of claim 1, wherein the flow generator is a pump or hydraulic flow generator.

5. The biological analysis system of claim 4, wherein the pump or hydraulic flow generator includes a metering pump or a gear pump configured to produce the bulk flow rate.

6. The biological analysis system of claim 1, further comprising a first flow restrictor along the first flow path configured to produce the first flow rate.

7. The biological analysis system of claim 6, further comprising a junction or valve positioned between the flow generator and the first flow restrictor that is configured to divide the fluid into the first and second portions.

8. The biological analysis system of claim 1, further comprising a second flow restrictor along the second flow path configured to produce the second flow rate.

9. The biological analysis system of claim 1, further comprising an imaging device configured to image the biological sample as the biological sample passes through the flowcell.

10. A biological analysis system comprising:
a fluid generator configured to provide a fluid;
a first flow path configured to receive a first portion of the fluid from the fluid generator;
a second flow path configured to receive a second portion of the fluid from the fluid generator;
a biological sample in fluid communication with the first flow path;
a flowcell configured for analysis of the biological sample, the flowcell comprising a first passageway and a second passageway;
wherein the first passageway is linked to the first flow path, such that the first portion of the fluid from the first flow path is configured to drive the biological sample from outside the flowcell through the first passageway of the flowcell; and
wherein the second passageway is linked to the second flow path, such that the second portion of the fluid from the second flow path is configured to be conveyed through the second passageway of the flowcell.

11. The biological analysis system of claim 10, wherein the first and second flow rates define a ratio, wherein the ratio is fixed.

12. The biological analysis system of claim 10, wherein the ratio being fixed between the first and second flow rates ensures that the biological analysis system is quantitatively consistent in response to the magnitude of the first and second flow rates changing due to at least one of viscosity or temperature.

13. A biological analysis system comprising:
a flow generator configured to provide a fluid;
a first flow path in fluid communication with both the flow generator and a flowcell;
a second flow path in fluid communication with both the flow generator and the flowcell;
the first flow path configured to convey a biological sample through an analysis region of the flowcell at a first flow rate;
the second flow path configured to convey a sheath fluid through the analysis region of the flowcell at a second flow rate;
wherein the first and second flow rates define a ratio, wherein the ratio is fixed.

14. The biological analysis system of claim 13, wherein the first flow rate and the second flow rate increase or decrease by the same percentage.

15. The biological analysis system of claim 13, wherein the flow generator is a pressure-based flow generator that includes a pressurized reservoir configured to produce the bulk flow rate at a first pressure.

16. The biological analysis system of claim 13, wherein the flow generator is a pump or hydraulic flow generator, wherein the pump or hydraulic flow generator includes a metering pump or a gear pump configured to produce the bulk flow rate.

17. A method of analyzing a biological sample comprising:
dividing a fluid, obtained from a flow generator, into a first flow path that contains a first portion of the fluid and a second flow path that contains a second portion of the fluid;
conveying a biological sample using the first portion of the fluid along the first flow path to a flowcell at a first flow rate;
conveying the second portion of the fluid to the flowcell at a second flow rate, wherein the second flow rate is different than the first flow rate; and
analyzing the biological sample within the flowcell.

18. The method of claim 17, wherein the method ensuring that the analysis is quantitatively consistent in response to the magnitude of the first and second flow rates changing due to at least one of viscosity or temperature by fixing the ratio between the first and second flow rates.

19. The method of claim 17, wherein dividing the fluid further comprises dividing the fluid using a junction or valve.

20. The method of claim 17, wherein dividing the fluid further comprises dividing the fluid using a three way valve.
